(19) United States
(12) Patent Application Publication
(10) Pub. No.: US 2002/0112409 A1
(43) Pub. Date: Aug. 22, 2002

(54) Method and apparatus for insulation

(76) Inventor: Stacey Glenn Knowles, Buford, GA (US)

Correspondence Address: HINKLE & O'BRADOVICH, LLC, 395 SCENIC HIGHWAY, LAWERENCEVILLE, GA, 30045, US

(21) Appl. No.: 10/051,400

(22) Filed: Jan. 18, 2002

Related U.S. Application Data
(60) Provisional application No. 60/262,523, filed on Jan. 18, 2001.

(51) Int. Cl. E06B 7/00

(52) U.S. Cl. 52/19; 52/203; 52/202; 182/77

(57) ABSTRACT

A method and apparatus for insulating apertures is disclosed. An insulating dome is placed over these apertures and can be locked into place, thereby providing insulation for the aperture. The apertures that are typically uninsulated are hidden stair openings and whole-house fans, plywood attic access passageways or other openings. The insulating dome can be lifted automatically once the hidden folding stair is opened or the whole-house fan is used.

### BACKGROUND OF THE INVENTION

1. Field of the Invention

The present invention relates generally to the field of insulation, and more particularly to a method and apparatus for insulating typically apertures that are left without insulation.

2. Description of the Related Art

Insulation is used in buildings and other structures to minimize heat loss from the structure during cold weather and to minimize heat flow into the structure and to keep cooler air inside the structure during warm weather. Many physical processes contribute to heat flow such as convection, conduction, radiation and other processes. Insulation is added to hinder these physical processes, thereby controlling the climate inside the structure. Insulation takes many forms such as fiber glass and styrofoam. Whatever the form, the goal is to hinder the aforementioned physical processes. Insulation is typically rated with “R” factors. The higher the R factor the better the insulation. R factors are typically determined both by the material used and the dimensions of the material.

Insulation is typically added to wall, ceiling and floor spaces. However, many apertures are typically left without insulation. Windows and doors and typically not insulated or are insulated with low R factor insulation or double panes. Stripping is also added around openings left around doors and windows. Other typical apertures left without insulation are ceiling openings for hidden stairs and apertures for “whole house” ceiling fans, and attic access passageways. For hidden stairs, a piece of ply board containing fold down stairs provides the only separation between the attic and the rest of the structure. Whole-house fans typically have an non-insulated lowered grill as the only separation between the outdoors climate and the structure.

### SUMMARY OF THE INVENTION

In accordance with the present invention and the contemplated problems which have and continue to exist in this field, in general, the invention features a method and apparatus insulating apertures in buildings, homes and other similar structures that are typically left non-insulated.

In general, in one aspect, the invention features an insulation apparatus, including an insulating dome having side pieces and a cover piece, thereby forming a recess within the side pieces and the top piece, the top pieces being generally elongated substantially forming a geometric shape, wherein the side pieces form a lower perimeter area and a base layer connected along the perimeter area, the base layer being adapted to connect to a resting spot.

In one implementation, the insulating dome is polystyrene.

In another implementation, the base layer is insulation.

In another implementation, the base layer is foam.

In another implementation, the base layer is magnetic tape.

In another implementation, the apparatus further includes a lifter connected to the dome.

In another implementation, the apparatus further includes locks connected to the dome.

In another implementation, the apparatus further includes a hinge connected to the dome and adapted to connect to a frame of a non-insulated aperture.

In another implementation, the apparatus further includes a pulley system connected to the dome and adapted to lift the dome from a non-insulated aperture.

In another implementation, the side pieces and the top piece further include male and female connectors adapted to interconnect the side pieces and the top piece to form the dome.

In another implementation, the side pieces and the top pieces are connected together by aluminum tape.

In another implementation, the side pieces and cover pieces are connected together by glue.

In another implementation, the side pieces and the top piece are a single integral piece.

In another aspect, the invention features an aperture insulation kit, including an insulating dome having side pieces and a cover piece, thereby forming a recess within the side pieces and the top piece, the top pieces being generally elongated substantially forming a geometric shape, wherein the side pieces form a lower perimeter area, a base layer adapted to connect to the perimeter area, a lifter connected to the dome and adapted to be connected to a frame of the aperture, locks connected to the dome and adapted to be connected to the frame of the aperture and hinges connected to the dome and adapted to be connected to the frame of the aperture.

In another implementation, the kit further includes a pulley system adapted to be interconnected between the dome and optionally the frame of the aperture and optionally to folding stairs connected to the frame of the aperture.

In another implementation, the base layer is an insulating material.

In another implementation, the kit further includes magnetic tape adapted to connect to the perimeter area and to a resting spot near aperture.

In another aspect, the invention features a method of insulating a non-insulated aperture, including providing an insulating dome over the aperture, optionally hinging the dome to a frame of the aperture, providing a base layer to the dome thereby filling any spaces formed between the dome and a resting spot near the aperture and securing the dome over the aperture when the aperture is not in use.

One advantage of the apparatus is that it provides insulation for areas of buildings that are typically left non-insulated.

Another advantage is that heat lost to typically non-insulated apertures is minimized.

Another advantage is that sound and other acoustical vibrations are reduced.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates a view of a ceiling having folding stairs and an embodiment of aperture insulation in a closed position;

FIG. 2 illustrates a view of a ceiling having folding stairs and an embodiment of aperture insulation in an open position; and

FIG. 3 illustrates another embodiment of an insulating dome over a whole house fan.

### DETAILED DESCRIPTION OF THE INVENTION

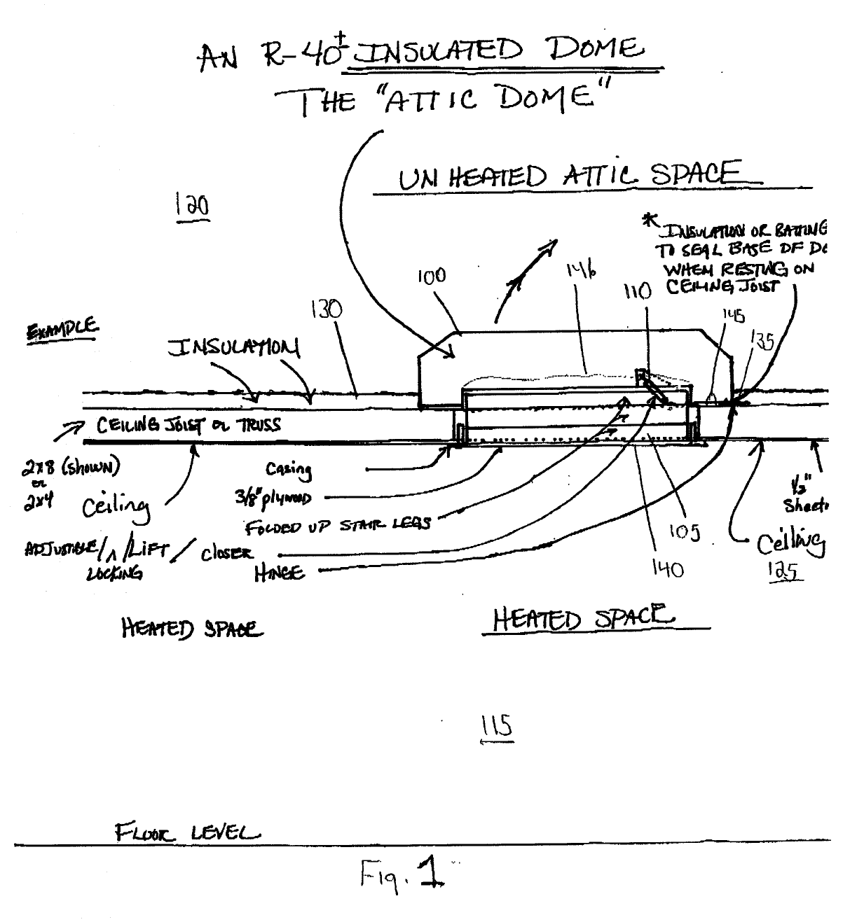

Referring to the drawings wherein like reference numerals designate corresponding parts throughout the several figures, reference is made first to FIG. 1 that illustrates a side view of a ceiling having folding stairs 105 and an embodiment of aperture insulation, or insulating dome (canopy, lid cover) 100 in a closed position. Typically, a ceiling 125 can include a hidden stair 105 that is capable of folding down into a heated space 115 of a building. The folding stair 105 is typically covered with a plywood casing 140. The casing 140 typically has a no R factor. The ceiling 125 also typically includes a layer of insulation 130 that is used to provide thermal insulation between the heated space 115 and an unheated space 120. The hidden stair 105 is not typically covered by the insulation 130. By including the insulating dome 100, the entire floor space of the unheated space 120 is insulated by the existing insulation 130 and the addition of the insulating dome 100.

In an embodiment, the aperture containing the hidden stair 105 is covered by an insulating dome 100 that covers the folding stair 105 aperture entirely. The insulating dome 100 is typically made out of an insulating material such as typical styrofoam and polystyrene. It is understood that the dome 100 can be made from any suitable insulating material. The insulating dome 100 generally includes side pieces and a cover piece, the side pieces being generally elongated, substantially forming a geometric shape such as a square or rectangle which typically accommodates non-insulated apertures, wherein the side pieces form a lower perimeter area.

The insulating dome 100 also includes a base insulation layer 135 that comes into contact with a resting spot. The layer 135 is typically connected to the lower perimeter area. The layer 135 can typically be any suitable insulating material that is flexible to help meet deformities on the resting spot. For example, the layer 135 can be polyurethane foam covered in a laminate. It is understood that the layer 135 can be any suitable material. The resting spot can be the ceiling joist or truss or an floor panel that was laid on the joists. The base layer 135 can be made out of a flexible insulating material that can take the shape of any irregularities on the floor, thereby creating an insulating seal between the resting spot and the insulating dome 100. In another embodiment, the dome 100 can use a layer of extra insulation surrounding the aperture instead of the base insulation layer. In another embodiment, magnetic tape can be used instead of the base insulation layer 135. Magnetic tape can be place along the perimeter of the dome as well as the resting spot around the aperture. When the two sections of magnetic tape come into contact, magnetic forces draw the two sections together forming a seal between the dome 100 and the resting spot around the aperture.

The insulating dome 100 can also include a hinge 145 that gives the insulating dome 100 a pivot point. The insulating dome 100 can also include an adjustable locking lifter/closer 110. The lifter closer can be a air pressurized plunger or any suitable form that aids in the lifting and closing of the insulating dome 100. In an implementation, the lifter/closer 110 can be adjusted to control the open and close speeds of the insulating dome 100. In another embodiment, the dome 100 can be manually lifted and put to the side without the aid of the hinge 145 and the lifter/closer 110. In another embodiment, the lifter closer 110 can be in the form of a lifter bar that can be pivotally attacked to the frame of the aperture space. When the dome 100 is opened, it can be kept in place by moving the lifter bar into a position at an angle to the dome 100 thereby holding the dome 100 in the desired place.

FIG. 1 further illustrates the dome 100 having an interior recess 146 allowing the insulating dome 100 to surround the folded stairs. The insulating dome can also include a series of locks around the dome 100. When the locks are engaged, a tighter seal can be created between the insulating base 135 and the resting spot, by pulling the dome 100 closer to the resting spot.

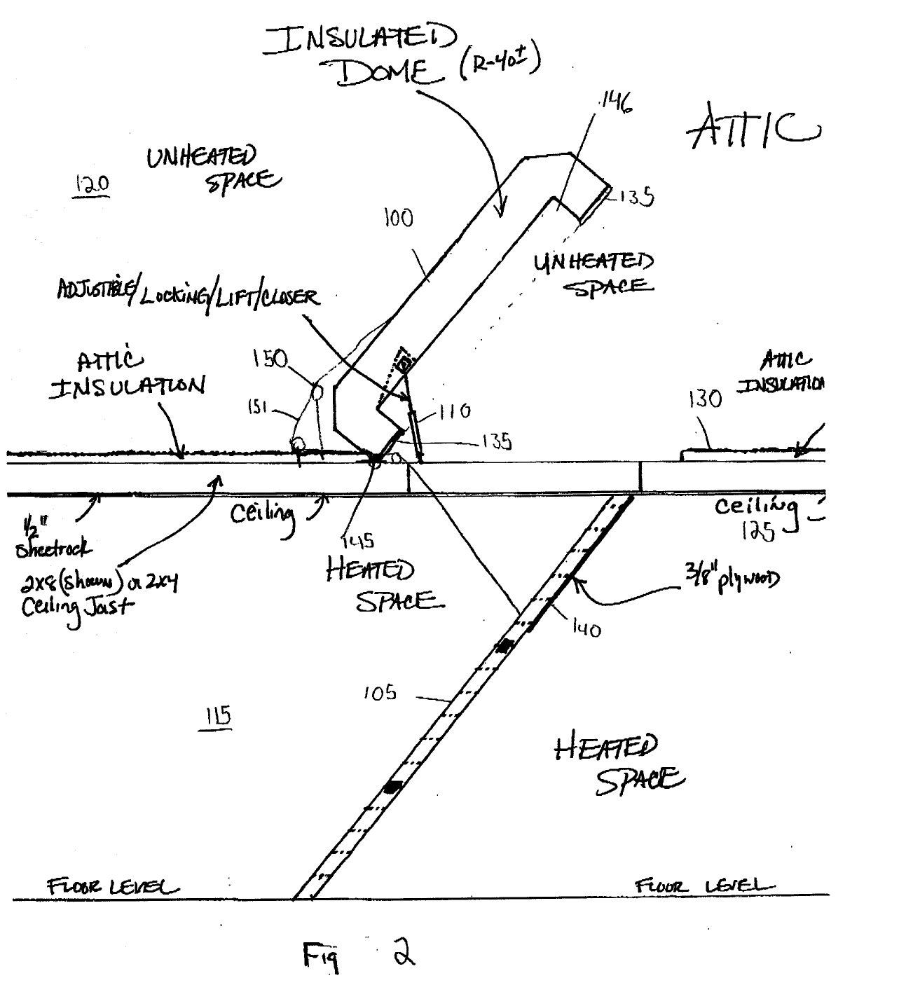

FIG. 2 illustrates a side view of a ceiling 125 having folding stairs 105 and an embodiment of aperture insulation, or insulting dome 100 in an open position. The folding stair 105 have been opened and the dome 100 has been opened using the hinge 145 as a pivot point. The lifter/closer 110 can be optionally locked into place.

In another embodiment, as shown in the figure, a series of pulleys 150 can be connected to the folding stairs 105 and to the insulating dome 100. When the stairs are unfolded and opened a cord 151, or any suitable string rope and the like, is pulled along the series of pulleys 150 that automatically lift the insulating dome 100 from the aperture. In this embodiment, the dome 100 pivots on the hinge 145 and expands the lifter/closer 110. In this way, the insulating dome 100 is automatically lifted off the aperture when the stairs 105 are unfolded, without the need of manually moving the dome 100.

If the insulating dome 100 includes locks, the cord can be loosened and the stairs 105 unfolded. In this way, the motion of opening and unfolding the stairs 105 does not automatically open the insulating dome 100. The locks can then be manually opened. At that point, the cord 151 can be pulled along the pulleys 150 to open the insulating dome 100.

The embodiment of the insulating dome described above is typically a one piece dome that can be manufactured accordingly in order to fit over varying sized folding stair, whole-house fan, plywood access passageway or other aperture. The following figures show an embodiment of an insulating dome at various views.

In another embodiment, the insulating dome described above, can be constructed from several pieces. Insulating domes may be added during construction of structures. However, since insulating domes may be added after the construction of the structure, it can advantageous to provide an embodiment of an insulating dome that is constructed from several pieces to allow for easy installation over existing apertures. Several pieces such as four sides and a top piece can be attached together to form the single insulating dome 100. It is understood that any number of pieces can be used to construct the insulating dome 100. The pieces can be attached in a variety of ways. For example, male and female connectors can be formed into each of the pieces in definite patterns so that the male and female connectors can be interconnected creating the single insulating dome. In another embodiment, the pieces can be connected together by the use of tape such as aluminum tape or any other suitable tape. In another embodiment, the pieces can be connected together by any suitable adhesive such as caulk or latex based glue, or any type of glue.

In other embodiments, the insulating dome 100 can typically be laminated or sealed with any suitable material such as but not limited to foil, tape, caulk, fiberglass and plastic. The lamination can be placed all around the dome for further insulation. The lamination can also serve to protect the insulating dome 100 from damage.

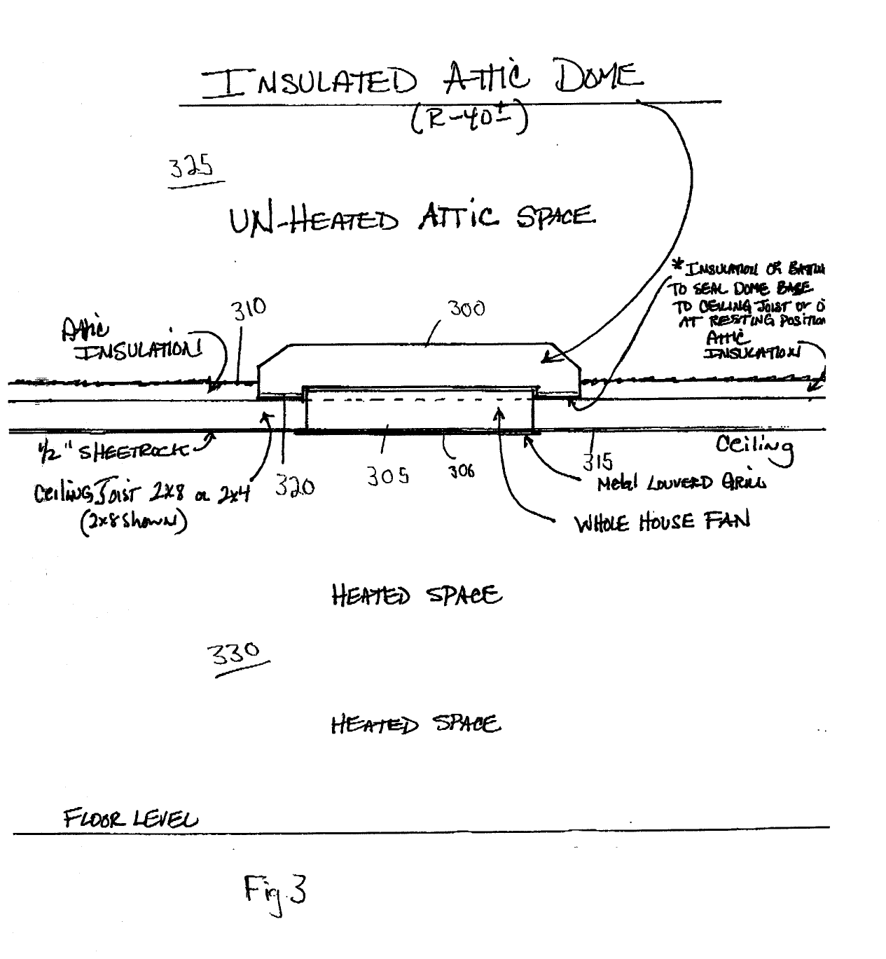

FIG. 3 illustrates another embodiment of an insulating dome 300 over a ceiling fan 305. The insulating dome 300 is shaped to fit over a “whole house” fan 305 when the fan 305 is not in use. The fan typically include a grate 306 covering the fan 305. Typically the ceiling 315 between the heated area 330 and the unheated area 325 includes insulation 310 that does not cover the aperture including the fan 305. The insulating dome 300 can be used to cover the aperture. The insulating dome includes a base insulating layer 320 that can form to irregularities in the area in which thee insulating dome 300 rests. In other embodiments, a layer of insulation, magnetic tape and other suitable replacements can be used instead of the base insulating layer, as described with respect to the insulating dome 100 discussed above. The insulating dome 300 typically does not have the same access requirements as the folding stairs 105 because a person does not need to move through the fan aperture. Therefore, the insulating dome 300 typically does not include hinges, lifters and pulleys, although these devices can be included in other implementations. Locks to form a better seal are typically desired.

In another embodiment, the insulating dome 300 described above, can be constructed from several pieces similar to the insulating dome 100. Insulating domes may be added during construction of structures. However, since insulating domes may be added after the construction of the structure, it can advantageous to provide an embodiment of an insulating dome that is constructed from several pieces to allow for easy installation over existing apertures. Several pieces such as four sides and a top piece can be attached together to form the single insulating dome 300. It is understood that any number of pieces can be used to construct the insulating dome 300. The pieces can be attached in a variety of ways. For example, male and female connectors can be formed into each of the pieces in definite patterns so that the male and female connectors can be interconnected creating the single insulating dome. In another embodiment, the pieces can be connected together by the use of tape such as aluminum tape or any other suitable tape. In another embodiment, the pieces can be connected together by any suitable adhesive such as caulk or latex based glue, or any type of glue.

A number of embodiments have been described. Nevertheless, is will be understood that various modifications may be made without departing from the spirit and scope of the invention. Several examples are now illustrated.

Many of the embodiments described above can be fit to industry standard hidden stair, whole-house fan, plywood access passageway fan or other aperture. However, it is understood that the dimensions can be varied accordingly for other applications and custom applications.

Typically, the materials used for the insulating dome and the dimensions of the insulating dome can be varied for different desired R factors and other insulating qualities.

In another embodiment, an insulating dome can be affixed to a door that separates a heated and unheated space. The dome for a door is similarly constructed as the dome embodiments described above.

Therefore, the foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. An insulation apparatus, comprising:
an insulating dome having side pieces and a cover piece, thereby forming a recess within the side pieces and the top piece, the top pieces being generally elongated substantially forming a geometric shape, wherein the side pieces form a lower perimeter area; and
a base layer connected along the perimeter area, the base layer being adapted to connect to a resting spot.

2. The apparatus as claimed in claim 1, wherein the insulating dome is polystyrene.

3. The apparatus as claimed in claim 1, wherein the base layer is insulation.

4. The apparatus as claimed in claim 1, wherein the base layer is foam.

5. The apparatus as claimed in claim 1, wherein the base layer is magnetic tape.

6. The apparatus as claimed in claim 1 further including a lifter connected to the dome.

7. The apparatus as claimed in claim 1 further including locks connected to the dome.

8. The apparatus as claimed in claim 1 further including a hinge connected to the dome and adapted to connect to a frame of a non-insulated aperture.

9. The apparatus as claimed in claim 1 further comprising a pulley system connected to the dome and adapted to lift the dome from a non-insulated aperture.

10. The apparatus as claimed in claim 1, wherein the side pieces and the top piece further include male and female connectors adapted to interconnect the side pieces and the top piece to form the dome.

11. The apparatus as claimed in claim 1, wherein the side pieces and the top pieces are connected together by aluminum tape.

12. The apparatus as claimed in claim 1, wherein the side pieces and cover pieces are connected together by glue.

13. The apparatus as claimed in claim 1, wherein the side pieces and the top piece are a single integral piece.

14. An aperture insulation kit, comprising:
an insulating dome having side pieces and a cover piece, thereby forming a recess within the side pieces and the top piece, the top pieces being generally elongated substantially forming a geometric shape, wherein the side pieces form a lower perimeter area;
a base layer adapted to connect to the perimeter area;
a lifter connected to the dome and adapted to be connected to a frame of the aperture;
locks connected to the dome and adapted to be connected to the frame of the aperture; and
hinges connected to the dome and adapted to be connected to the frame of the aperture.

15. The kit as claimed in claim 14 further comprising a pulley system adapted to be interconnected between the dome and optionally the frame of the aperture and optionally to folding stairs connected to the frame of the aperture.

16. The kit as claimed in claim 14, wherein the base layer is an insulating material.

17. The kit as claimed in claim 14 further including magnetic tape adapted to connect to the perimeter area and to a resting spot near aperture.

18. A method of insulating a non-insulated aperture, comprising:
providing an insulating dome over the aperture;
optionally hinging the dome to a frame of the aperture;
providing a base layer to the dome thereby filling any spaces formed between the dome and a resting spot near the aperture; and
securing the dome over the aperture when the aperture is not in use.
